(19) United States
(12) Patent Application Publication
(10) Pub. No.: US 2022/0329664 A1
(43) Pub. Date: Oct. 13, 2022

(54) SECURE DATA CACHING FOR EDGE NETWORKS

(71) Applicant: Apple Inc., Cupertino, CA (US)

(72) Inventors: Srinivas VEDULA, Fremont, CA (US); Joel N. KERR, San Jose, CA (US); Qihe WANG, San Jose, CA (US); Yuehhsun LIN, Mountain View, CA (US); Ranjit DESAI, Cupertino, CA (US)

(21) Appl. No.: 17/590,810

(22) Filed: Feb. 1, 2022

Related U.S. Application Data
(60) Provisional application No. 63/173,358, filed on Apr. 9, 2021.

(51) Int. Cl. H04L 67/01; G06F 15/173

(52) U.S. Cl. CPC H04L 67/42; G06F 15/17331; H04L 63/123

(57) ABSTRACT

The disclosed technology provides for secure data caching by an edge network for an electronic device. The secure data caching can be provided by including a personal edge network and a remote edge network in the edge network. The remote edge network may include storage nodes that are accessible by multiple users. The personal edge network may include devices that are associated with the electronic device and a user of the electronic device, and that have been enrolled as storage nodes of the personal edge network.

### CROSS REFERENCE TO RELATED APPLICATIONS

This application claims the benefit of priority to U.S. Provisional Patent Application No. 63/173,358, entitled “Secure Data Caching For Edge Networks,” filed on Apr. 9, 2021, the disclosure of which is hereby incorporated herein in its entirety.

### TECHNICAL FIELD

The present description relates generally to edge computing, including, for example, secure data caching in an edge network.

### BACKGROUND

Edge computing systems attempt to efficiently provide computing resources that are geographically near to the location at which the result of the computing is to be output to a user or to be used for processing by another system. However, it can be challenging to provide edge computing systems that protect the privacy of user-related data.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement one or more aspects of the subject technology in accordance with one or more implementations.

FIG. 2 illustrates an example of an electronic device obtaining data from a data source in accordance with one or more implementations.

FIG. 3 illustrates an example of an electronic device offloading data for secure caching by an edge network in accordance with one or more implementations.

FIG. 4 illustrates an example of an electronic device obtaining securely cached data from an edge network in accordance with one or more implementations.

FIG. 5 illustrates another example of an electronic device obtaining securely cached data from an edge network in accordance with one or more implementations.

FIG. 6 illustrates a flow chart of example operations for secure data caching in accordance with one or more implementations.

FIG. 7 illustrates another flow chart of example operations for secure data caching in accordance with one or more implementations.

FIG. 8 conceptually illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

It can be desirable to move data, for use by an electronic device, to a storage node that is geographically near the electronic device, such as to increase data availability for the electronic device, reduce network bandwidth usage by the electronic device, and/or reduce computing and/or power resources used to obtain and/or transmit the data. However, some data can be sensitive and/or private data, sometimes referred to herein as user-related data, user-specific data or controlled data. In order to protect the privacy of users and/or their private data, movement, storage, and access to such private data can be limited, which can limit the use and/or availability of edge computing resources for an electronic device.

In accordance with aspects of the disclosure, efficient and secure access to data, including secure data such as personally identifiable data (PII) of a user, and including potentially large quantities of additional data that is unrelated to a user, may be provided. The efficient and secure data access systems and method disclosed herein include efficient and secure distribution of different types of data to different types of off-device storage devices, which can be beneficial to, for example, a resource-limited device such as a mobile device or a wearable device.

In one or more implementations, for a given device that is associated with a user, data storage may be distributed among storage nodes of a personal edge network and storage nodes of a remote edge network. The personal edge network may include other devices of the user (e.g., the user's phone, tablet, laptop, computer, etc.). The remote edge network may be, for example, a cloud storage network associated with a manufacturer of the device and/or an account of the user.

Efficient and secure access to data can be provided of an electronic device, by predictively moving secure data, such as PII, among only the nodes of the personal edge network (e.g., into a secure data asset cache), and predictively moving potentially larger datasets such as application data or public data, among the nodes of the remote edge network. This type of edge-aware data management can be applied to data generated by a device, and/or data obtained by a device from a remote server or device in various implementations.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In one or more implementations, the secure off-device data asset caching operations described herein can be applied to provide efficient off-device storage and access to data for one or more XR applications. For example, the systems and methods described herein can be used to securely and off-device store PII associated with an avatar of a user for efficient access, and/or to store user-unrelated data for generation of an XR environment that includes the avatar of the user. In other implementations, the secure off-device data asset caching operations described herein can be applied to network browsing data, maps data, social media data, or any other suitable data.

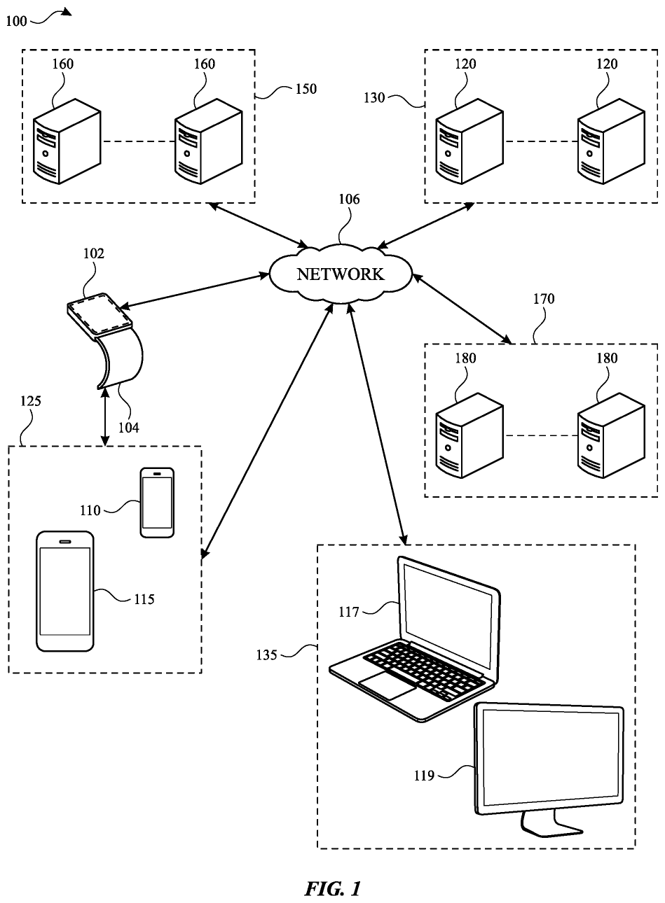

FIG. 1 illustrates an example system 100 for secure data caching in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example of FIG. 1, the system 100 includes an electronic device 102, an electronic device 110, an electronic device 115, an electronic device 117, an electronic device 119, a network 106, and one or more servers 120, one or more servers 160, and one or more servers 180. The network 106 may communicatively (directly or indirectly) couple, for example, any two or more of the electronic device 102, the electronic device 110, the electronic device 115, the electronic device 117, the electronic device 119, the one or more servers 120, the one or more servers 160, and the one or more servers 180.

As illustrated in FIG. 1, various devices and/or servers can be located in any of various geographical regions. For example, in FIG. 1, the electronic device 110 and the electronic device 115 are in a geographical region 125 that is near, or proximal to the geographical location of the electronic device 102. In this example, the electronic device 117 and the electronic device 119 are in a different geographical region 135. In this example, the servers 120 are in a geographical region 130, the servers 160 are in a geographical region 150, and the servers 180 are in a geographical region 170.

As the electronic device 102 is moved from place to place (e.g., when carried or worn by a user of the electronic device 102), the various devices and/or servers (e.g. various ones of the electronic device 102, the electronic device 110, the electronic device 115, the electronic device 117, the electronic device 119, the one or more servers 120, the one or more servers 160, and the one or more servers 180) may be geographically nearer or further than various other devices and/or servers at any given time.

The system 100 may represent an edge computing system that includes a personal edge network and a remote edge network for the electronic device 102. In the example of FIG. 1, the personal edge network may include the electronic device 110, the electronic device 115, the electronic device 117, and/or the electronic device 119. For example, the electronic device 110, the electronic device 115, the electronic device 117, and/or the electronic device 119 may be associated with the electronic device 102 and a user of the electronic device 102. For example, the electronic device 110, the electronic device 115, the electronic device 117, and/or the electronic device 119 may have each been previously enrolled (e.g., with a server such as one of servers 160 or one of servers 180) as personal storage nodes of the personal edge network for the electronic device 102. In one or more implementations, the electronic device 110 and/or the electronic device 115 may be a companion device for the electronic device. For example, the electronic device 110 and/or the electronic device 115 may be associated with a common user account of the user of the electronic device 102, and/or may be paired with the electronic device 102. As indicated in FIG. 1, the electronic device 110 and/or the electronic device 115 may communicate directly (e.g., via direct WiFi and/or Bluetooth) with the electronic device 102, when in proximity to the electronic device 102.

In the example of FIG. 1, the remote edge network may include one or more storage nodes that are accessible by multiple devices of multiple users, such as one or more storage nodes associated with one servers 160 and/or servers 180. In one or more implementations, the servers 160 and the servers 180 may be remote servers associated with the manufacturer of the electronic device 102. In one or more implementations, one or more of the servers 160 and/or one or more of the servers 180 may be configured to enroll the electronic device 110, the electronic device 115, the electronic device 117, and/or the electronic device 119 as storage nodes of the personal edge network for the electronic device 102.

For example, one or more of the servers 160 and/or one or more of the servers 180 may manage and/or store an account of the electronic device 102 that is common to the electronic device 110, the electronic device 115, the electronic device 117, and/or the electronic device 119. One or more of the servers 160 and/or one or more of the servers 180 may be configured to enroll the electronic device 110, the electronic device 115, the electronic device 117, and/or the electronic device 119 by, for each device, receiving a request for enrollment of the electronic device, verifying one or more properties (e.g., hardware properties, software properties, account properties, permissions, etc.) of the device; and providing, to the device based on the verifying, a certificate of enrollment as a storage node of the personal edge network.

Once enrolled, the electronic device 110, the electronic device 115, the electronic device 117, and/or the electronic device 119 can be an off-device edge storage node of a personal edge network for the electronic device 102. For example, the electronic device 102 may use one or more of the electronic device 110, the electronic device 115, the electronic device 117, and/or the electronic device 119 as a storage node of the personal edge network, while the electronic device 102 is at or near the geographical region in which that device is located. The electronic device 102 can offload secure or private data to the electronic device 110, the electronic device 115, the electronic device 117, and/or the electronic device 119 for secure storage. The electronic device 110, the electronic device 115, the electronic device 117, and/or the electronic device 119 can also pull secure data from another of the electronic device 110, the electronic device 115, the electronic device 117, and/or the electronic device 119 that is located further from the electronic device 102 (e.g., in advance of the data being used by the electronic device 102), in order to provide efficient access to the secure data for the electronic device 102.

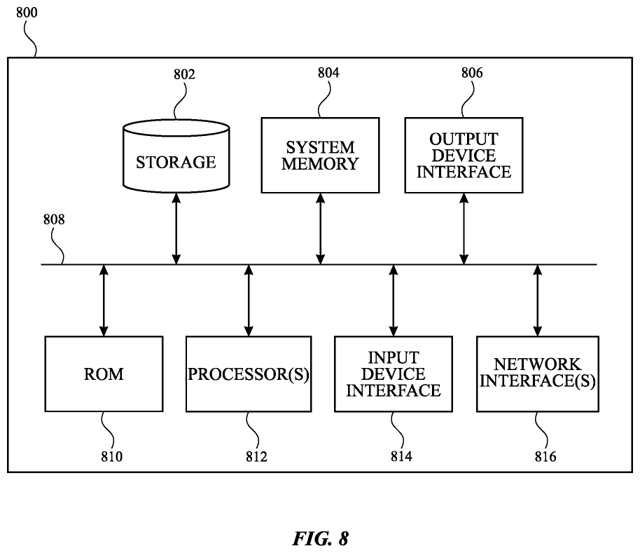

In one or more implementations, one or more of the servers 120 may be remote sources of data for the electronic device 102. For example, one or more of the servers 120 may be a remote server of a third party different from a manufacturer of the electronic device 102. For example, the servers 120 may be web servers, merchant servers, mapping servers, catalog servers, streaming servers, or other remote data sources that can be accessed via the network 106. One or more of the servers 160 and the servers 180 that is in or near the geographical region of the electronic device 102 may receive non-private and/or non-user-related data from the electronic device 102 for storage, and/or can pull non-private and/or non-user-related data from the servers 120 and/or from another of the servers 160 and the servers 180. In this way, the remote storage nodes of the remote edge network can provide efficient access to non-private and/or non-user-related data (e.g., general data) the by the electronic device 102. The servers 120, the servers 160, and/or the servers 180 may be, and/or may include all or part of, the electronic system discussed below with respect to FIG. 8.

In one or more implementations, the network 106 may be an interconnected network of devices that may include, or may be communicatively coupled to, the Internet. In one or more implementations, the electronic device 102 and the electronic device 110, the electronic device 115, the electronic device 117, and/or the electronic device 119 can communicate over a direct link (e.g., a wired or wireless link such as a WiFi connection or a Bluetooth connection), and/or an indirect link, such as through the network 106, and/or one or more intermediary devices and/or servers. For explanatory purposes, the system 100 is illustrated in FIG. 1 as including the electronic device 102, the electronic device 110, the electronic device 115, the electronic device 117, the electronic device 119, the one or more servers 120, the one or more servers 160, and the one or more servers 180; however, the system may include any number of electronic devices and servers.

The electronic device 102 may be, for example, a portable computing device such as a laptop computer, a smartphone, a peripheral device (e.g., a digital camera, headphones), a tablet device, a wearable device such as a watch or a head mountable device, a band, and the like, or any other appropriate device that includes one or more wireless interfaces, such as near-field communication (NFC) radios, WLAN radios, Bluetooth radios, Zigbee radios, cellular radios, and/or other wireless radios. In FIG. 1, by way of example, the electronic device 102 is depicted as a wearable device (e.g., a smart watch) having an attachment feature 104 (e.g., a strap) for securing the device to the body of the user. The electronic device 102 may be, and/or may include all or part of, the electronic system discussed below with respect to FIG. 8.

The electronic device 110, the electronic device 115, the electronic device 117, and the electronic device 119 may each be implemented as, for example, any of a portable computing device such as a laptop computer, a smartphone, a peripheral device (e.g., a digital camera, headphones), a tablet device, a wearable device such as a watch or a head mountable device, a band, and the like, or any other appropriate device that includes one or more wireless interfaces, such as near-field communication (NFC) radios, WLAN radios, Bluetooth radios, Zigbee radios, cellular radios, and/or other wireless radios. In FIG. 1, by way of example, the electronic device 110 is depicted as smartphone, the electronic device 115 is depicted as a tablet device, the electronic device 117 is depicted as a laptop computer, and the electronic device 119 is depicted as a desktop computer (e.g. a computer integrated into a display). The electronic device 110, the electronic device 115, the electronic device 117, and/or the electronic device 119 may be, and/or may include all or part of, the electronic system discussed below with respect to FIG. 8.

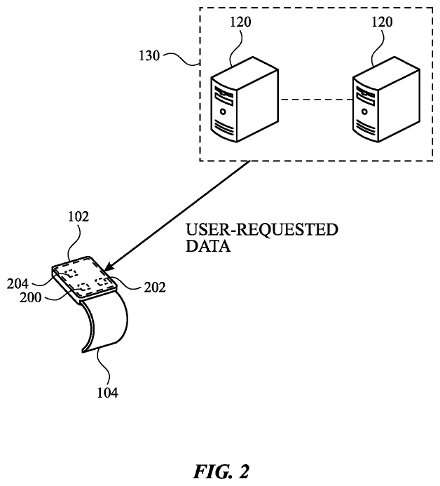

FIGS. 2-5 illustrate various examples of operations (e.g., data transmissions and/or exchanges) that can be performed by one or more components of the system 100. For example, as illustrated in FIG. 2, electronic device 102 may obtain data, such as user-requested data, from a remote data source such one as one or more of servers 120. The user-requested data may include web browsing data, shopping data, streaming data (e.g., video data or audio data), mapping data, gaming data, service data, or any other data obtainable from a remote device or server. The user-requested data (and/or other data such as application-requested data) may be obtained by electronic device 102, for example, regularly by a user of the electronic device 102, and/or by an application 204 running at the device, in one or more implementations. For example, the user may obtain map data each morning on the way to work or at a bus stop, the user may obtain catalog data each afternoon while shopping online, or the user may obtain XR data on Saturdays while running an XR application (as examples).

The electronic device 102 may also obtain and/or generate user-related data 200 associated with the user-requested data. For example, although the servers 120 may host large amounts of publicly available data, the specific portion of the public data that is obtained by the electronic device 102, the timing obtaining the data, the frequency of obtaining the data, the location of the electronic device 102 while obtaining the data, etc., is user-related data that should not be revealed to other devices and/or servers without the explicit permission of the user. The electronic device 102 may have a data manger 202 that ensures that the user-related data 200 is securely stored at the electronic device 102 and/or is only provided to the personal edge network when external storage of the user-related data is desired.

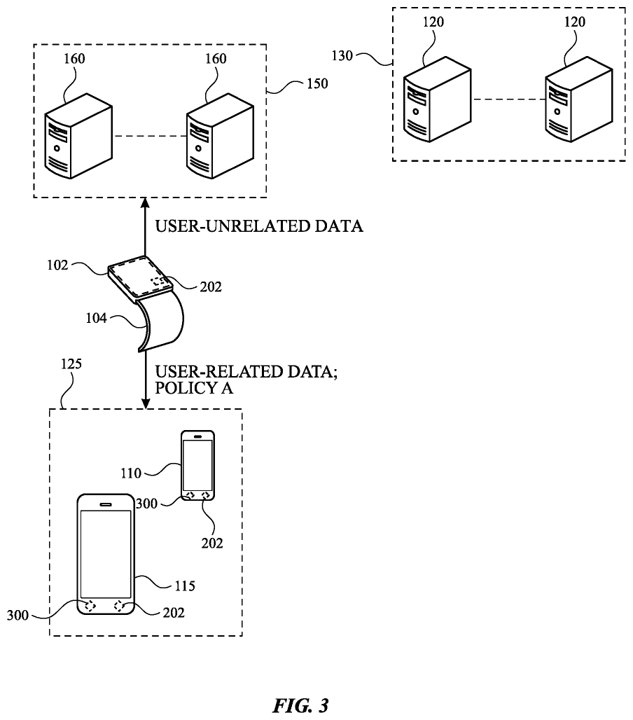

For example, FIG. 3 illustrates an example scenario in which the electronic device 102 (e.g., to conserve storage, computing, and/or power resources at the electronic device 102), offloads user-related data to a storage node (e.g., electronic device 110 and/or electronic device 115) of the personal edge network (e.g., storage nodes in the geographical region 125 that is nearest to the electronic device 102). As shown in FIG. 1, the data manager 202 of electronic device 102 may generate a policy (e.g., “Policy A”) that governs the storage and/or usage of the user-related data, and may provide the policy to a data manager 202 at the storage node (e.g., at the electronic device 110 and/or electronic device 115) that receives the user-related data. The data manager 202 at the storage node that receives the user-related data may manage storage and/or usage of the user-related data for that storage node, according to the received policy. For example, the policy may indicate that the user-related data is not to be transferred outside of the personal storage network. As another example, the policy may indicate hardware and/or software properties of the storage nodes that can or cannot receive the user-related data. FIG. 3 also indicates how each of the storage nodes of the personal edge network (e.g., electronic device 110 and/or electronic device 115) may store a certificate 300 that indicates that the device has been enrolled as a storage node of the personal edge network.

FIG. 3 also shows how user-unrelated data (e.g., publicly available data) may be offloaded to one or more storage nodes of a remote edge network (e.g., to a storage node associated with one or more of the servers 160 that are in a nearby geographical region of the electronic device 102).

In one or more implementations, the servers 160 may move the user-unrelated data to one or more other servers and/or storage nodes of the remote edge network after receiving the user-unrelated data from the electronic device 102. In one or more implementations, the data manager(s) 202 of the storage nodes of the personal edge network may move the user-related data to one or more other storage nodes of the personal edge network, according to the received policy, after receiving the user-related data from the electronic device 102. Because the user-unrelated data and/or the user-related data can be moved, and/or because the electronic device 102 can physically move to a new geographic region after offloading the data, the system 100 (e.g., one or more of the data managers 202, the servers 160 and/or the servers 180) can predictively move the user-related data among the storage nodes of the personal edge network and/or predictively move the user-unrelated data among the storage nodes of the remote edge network, to position the data for efficient upcoming access to the data by the electronic device 102.

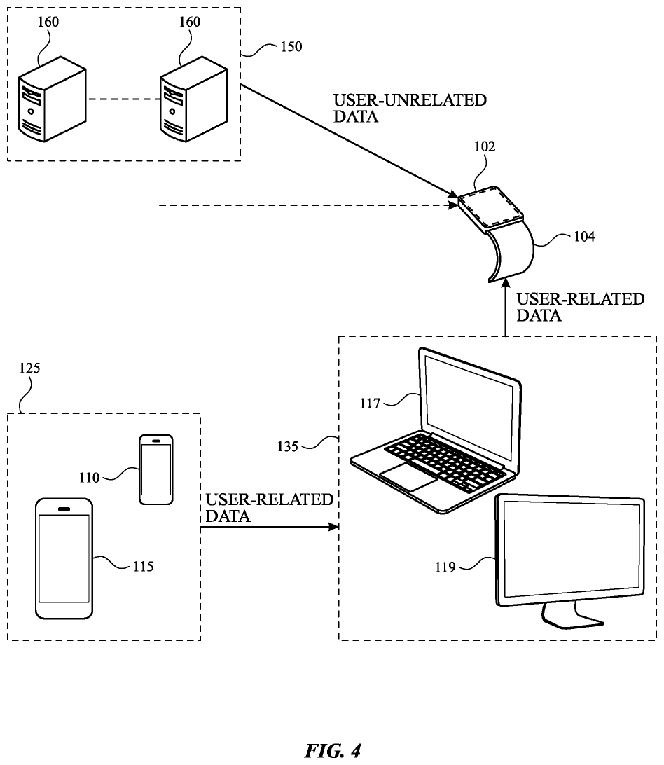

For example, as illustrated in FIG. 4, one or more of the electronic device 102, electronic device 110, the electronic device 115, the electronic device 117, and/or the electronic device 119 may predict an upcoming access of data by a user using the electronic device 102, based on prior user activity at the electronic device 102 (e.g., based on a user history of operating an application, or obtaining a certain type of data). The electronic device 102, electronic device 110, the electronic device 115, the electronic device 117, and/or the electronic device 119 (e.g., data managers 202 of the devices) may predictively move the user-related data to a nearby storage node of the personal edge network, to be re-obtained by the electronic device 102, as illustrated in FIG. 4.

In the example of FIG. 4, the user-unrelated data is re-accessed from the remote edge network (e.g., from the same servers 160 to which the user-unrelated data was offloaded). However, it is also appreciated that the electronic device 102, electronic device 110, the electronic device 115, the electronic device 117, and/or the electronic device 119 predictively move the user-unrelated data to a nearby storage node of the remote edge network in some operational scenarios (e.g., if the electronic device 102 has moved closer to one of servers 180).

In this way, the user-related data, and user-unrelated data can be offloaded from the electronic device 102 when not needed at the electronic device 102, and efficiently available to be re-accessed by the electronic device 102 at an access time that has been scheduled in advance or predicted by the system. In the example of FIG. 4, the electronic device 102 accesses the user-unrelated data from the same storage nodes of the remote data network to which the data was transferred from the electronic device 102 and accesses the user-related data from different storage nodes of the personal data network from those to which the data was transferred from the electronic device 102. However, it is appreciated that the electronic device 102 and/or the user-related data and/or the user-unrelated data may be moved among the corresponding edge network during a time period between the offloading from the electronic device 102 and the re-access by the electronic device 102. In various scenarios, depending, for example, on the location of the electronic device 102, only one of user-unrelated data and the user-related data may be moved or neither of the user-related data have may be moved among the respective edge networks.

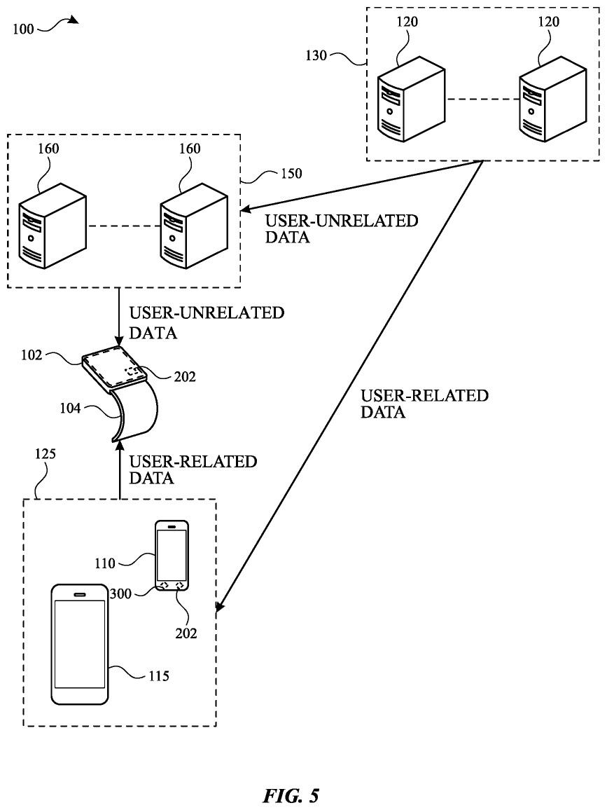

In one or more implementations, the system 100 can also, prior to a predicted upcoming access or use of data at the electronic device 102, obtain data (e.g., new data and/or data previously stored and removed from the edge network) from a remote source, as illustrated in the example of FIG. 5. For example, a first portion of the data that is related to the user (e.g., user-specific data) can be cached off-device in advance to an off-device storage node of the personal edge network, and a second portion of the data that is unrelated to the user (e.g., general data) can be cached in advance to a remote storage node of the remote edge network, as shown in FIG. 5. For example, the predictively obtained data that is related to the user may be related to the prior user activity, such as previous activity for obtaining the user-related or similar data.

In one operational example, a user may use electronic device 102 to browse a catalog provided by the servers 120. At a later time, the system 100 may predict (e.g., using a machine learning model and the history of the catalog browsing) that the user will soon attempt to access a particular portion of the catalog. In one or more implementations, the prediction may be based on PII such as user browsing data (e.g., the browsing history itself, such as which portion of the catalog the user has view, such as at particular times of the day or week) or eye-tracking data of the user (e.g., tracking of particular products or images that are viewed by the user's eyes during the browsing). In order to have the portion of the catalog ready for predicted upcoming access by the user, without exposing the user PII to the servers 120, the servers 160 or elsewhere outside the permissions of the data manager 202, the PII used to identify the particular portion of the catalog, and the particular portion of the catalog identified using the PII, may be pre-stored at a companion device of the user (e.g., the user's phone) that is within the user's personal edge network. The wider catalog, which is unassociated with the user, may also be downloaded to an edge node of the remote edge network for potential user access of the other portions of the catalog, in a way that is more efficient than would occur if the catalog were accessed directly by electronic device 102 from its original remote source.

In one or more implementations, the system 100 may determine (e.g., based on user scheduling or tasks, based on information provided from an application at the electronic device 102, and/or based on device-learned predictions) that data stored at the electronic device 102 and/or a storage node of the personal edge network for the electronic device 102 is not likely to be needed until a later time (e.g., tomorrow morning). In this scenario, the data may be moved from the electronic device 102 to a node of the personal edge network, or can be removed from the system entirely and pulled down from a remote source to a node of the personal edge network prior to the upcoming expected user access (e.g., the next morning). In one or more implementations, a server such as one or more servers 160 and/or servers 180, may be authorized by the user to store some PII, such as for photo storage at a cloud server. In one or more implementations, when an application at the electronic device 102, or the user of the electronic device 102, is predicted to or is actively using one or more of the photos, the photos may be downloaded from the cloud server to a storage node of the personal edge network. Photos generated by the electronic device 102 may be offloaded to one or more of the storage nodes of the personal edge network instead of to the cloud storage, in some scenarios.

In one or more implementations, movement of data within the remote edge network and/or within the personal edge network may be opaque to applications such as application 204 at the electronic device 102. For example, an application at the electronic device 102 may simply request the data as needed, and receive the data more efficiently than would otherwise be available without the secure caching capabilities of the personal edge network. In one or more implementations, off-device cached data that is stored by the personal edge network and/or the remote edge network may be removed from the edge storage nodes (e.g., after a predetermined amount of time of non-use). In one or more implementations, data that is removed from nearby edge storage nodes may be securely stored on more remote storage node (e.g., a storage node have more memory and/or computing resources than the nearby node) within the same edge network (e.g., within the personal edge network or within the remote edge network) after a certain amount of time of non-use on the nearby edge device (e.g., to preserve the data for potential future use).

In one or more implementations, a data manager 202 at the electronic device 102 may attempt to discover another device as a target for secure caching of PII, and can use the certificates 300 stored at any communicatively coupled devices (and provisioned to enroll that device as a storage node) to identify an available node of the personal edge network. In one or more implementations, the certificates 300 may also be used to establish a secure connection with a storage node of the personal edge network. In one or more implementations, the secure connection may be established using a key pair that is associated with the electronic device 102 and the storage node of the personal edge network (e.g., a key pair associated with an account of the user of the electronic device 102 and the storage node of the personal edge network and previously exchanged between the electronic device 102 and the storage node of the personal edge network). In one or more implementations, a user can remove a device from the personal edge network by removing/deleting the certificate 300 that was provisioned to enroll that device as a storage node.

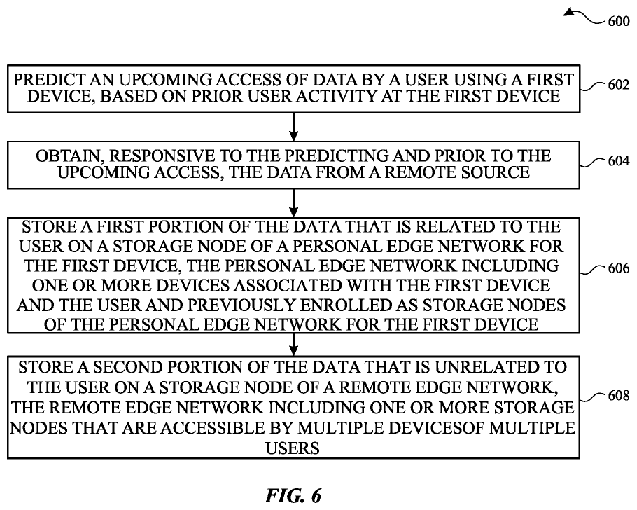

FIG. 6 illustrates a flow diagram of an example process 600 for secure data caching in accordance with implementations of the subject technology. For explanatory purposes, the process 600 is primarily described herein with reference to the electronic device 102 of FIG. 1. However, the process 600 is not limited to the electronic device 102 of FIG. 1, and one or more blocks (or operations) of the process 600 may be performed by one or more other components of other suitable devices. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, one or more components of an edge network (e.g., one or more of the data managers 202, the servers 160 and/or the servers 180) may predict an upcoming access of data by a user using a first device (e.g., electronic device 102), based on prior user activity at the first device. For example, the first device may perform the predicting. The prior user activity may include browsing activity, gaming activity, streaming activity, XR activity, shopping activity, social media activity, communications activity, or the like. The predicted upcoming access of the data may be a prediction of a re-access of the same data accessed during the prior user activity, or a prediction of a new access of data similar to or related to data accessed during the prior user activity.

At block 604, the edge network may obtain, responsive to the predicting and prior to the upcoming access, the data from a remote source (e.g., a remote server such as servers 120 of FIG. 4). For example, the remote source may be a remote server of a third party different from a manufacturer of the first device. For example, the first device may, responsive to the predicting and prior to the upcoming access, instruct a personal storage node of a personal edge network for the first device to obtain and store a first portion of the data that is related to the user (e.g., a user-specific portion of the data). For example, the first device may, responsive to the predicting and prior to the upcoming access, instruct a remote storage node of a remote edge network to obtain and store a second portion of the data that from the remote source, the second portion of the data unrelated to the user (e.g., a general portion of the data).

At block 606, a first portion of the data that is related to the user (e.g., a user-specific portion of the data) may be stored on a storage node of a personal edge network for the first device. The personal edge network may include one or more devices (e.g., the electronic device 110, the electronic device 115, the electronic device 117, and/or the electronic device 119) associated with the first device and the user and previously enrolled as storage nodes of the personal edge network for the first device. In one or more implementations, each of the one or more enrolled devices associated with the first device forms and off-device personal storage node of the personal edge network for the first device, the off-device personal storage node being separate from the first device. For example, the data that is related to the user may be related to the prior user activity. For example, in one or more implementations, the data that is related to the user may be a portion of otherwise publicly available data, that is related to the user due to a learned user interest in that portion of the otherwise publicly available data. For example, the data that is related to the user may be a particular bus route that is publicly available along with all other bus routes in a city, and that has been learned (e.g., by the electronic device 102 and/or one or more other devices and/or servers that are associated with the user) to be bus route that is commonly and/or regularly searched, viewed, and/or travelled by the user of the first device (e.g., at a particular time on each weekday). In one or more implementations, the personal edge network may include at least one companion device (e.g., the electronic device 110) for the first device. The companion device and the first device may both be associated with a common user account of the user. For example, the common user account may be a user account with a server such as one of servers 160 and/or servers 180, and/or a user account associated with a manufacturer or a service provider for the first device.

At block 608, a second portion of the data that is unrelated to the user (e.g., general data) may be stored on a storage node of a remote edge network (e.g., a storage node that is geographically nearer to the user and/or the first device than the remote data source). The remote edge network may include one or more storage nodes (e.g., one or more storage nodes associated with one or more of servers 160 and/or servers 180) that are accessible by multiple devices of multiple users (e.g., multiple users that have accounts with the remote edge network or the remote storage nodes). In the example described above in connection with block 606, the data that is unrelated to the user may be a full set of bus routes that are publicly available. By obtaining the data that is unrelated to the user from the remote source and storing the data that is unrelated to the user on a storage node of a remote edge network, the data that is unrelated to the user can be predictively stored at a location that is geographically nearer to the user and/or the first device than the remote data source. In this way, the data that is unrelated to the user may be more readily available to the user, if the user should decide, for example, to search for other bus routes in the city.

In one or more implementations, the remote edge network may include one or more remote servers (e.g., servers 160 and/or servers 180) of the manufacturer of the first device. In one or more implementations, the personal edge network for the first device may be generated by enrolling each of one or more devices associated with the first device as storage nodes of the personal edge network for the first device. In one or more implementations, enrolling devices associated with the first device as storage nodes of the personal edge network for the first device may include, for each of the one or more devices associated with the first device, receiving a request (e.g., from the first device or from a current one of the devices to be enrolled) for enrollment of the current one of the one or more devices, at a server (e.g., one or more of servers 160 and/or servers 180) associated with an account of the first device and the current one of the one or more devices. The server may verify one or more properties of the current one of the one or more devices, and provide, to the current one of the one or more devices based on the verifying, a certificate of enrollment as a storage node of the personal edge network. For example, the server may determine that a device to be enrolled includes one or more hardware and/or software properties (e.g., a touchscreen, a stylus, a neural processor, a graphics processing unit, an application, an operating system, etc.) that make that device suitable, unsuitable, or preferred for storing and/or processing data of one or more types. In one or more implementations, the server may include information in the provisioned certificate for the device that indicates which of various types of data can be transferred to that device for secure caching.

It is also appreciated that the data manager 202 at the electronic device 102 may also set policies for which storage nodes of the personal edge network can receive data of various types. For example, for data that is preferably processed on a secure neural processor, the data manager may set a policy for that data, the policy indicating to never move that data to a storage node that does not have a secure neural processor. In this way, the electronic device 102 can also efficiently utilize a particular edge storage node in the personal edge network for off-device edge computing processes for that data, in one or more implementations.

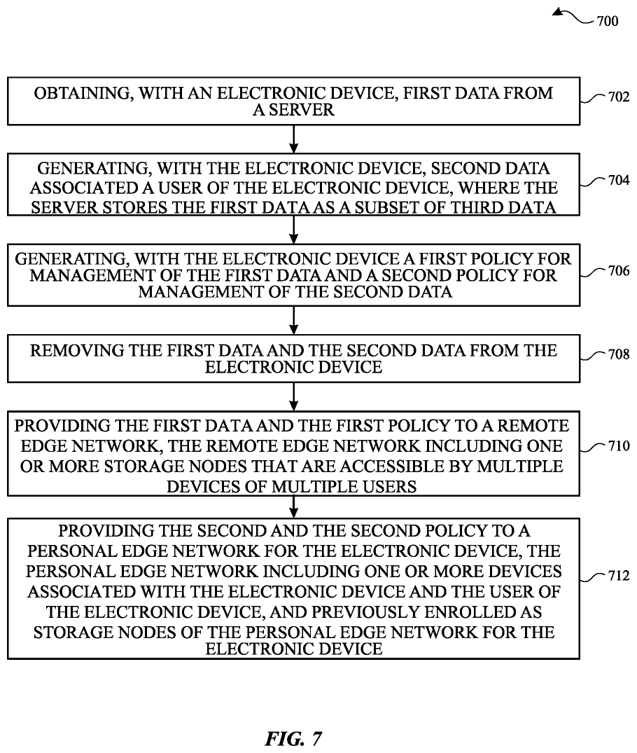

FIG. 7 illustrates a flow diagram of another example process 700 for secure data caching in accordance with implementations of the subject technology. For explanatory purposes, the process 700 is primarily described herein with reference to the electronic device 102 FIG. 1. However, the process 700 is not limited to the electronic device 102 of FIG. 1, and one or more blocks (or operations) of the process 700 may be performed by one or more other components of other suitable devices. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, an electronic device (e.g., electronic device 102) may obtain first data from a server (e.g., one or more of servers 120 unassociated with the electronic device or one or more of servers 160 and/or 180 associated with the electronic device). In one or more implementations, the electronic device may be smart phone, a tablet device, a laptop computer, a desktop computer, or a wearable device, such as a head mountable device or a smart watch.

At block 704, the electronic device may generate second data associated a user of the electronic device. The server may also store the first data as a subset of third data. For example, in one or more implementations, the third data may include XR scene information for a multiple XR scenes, the first data may include the XR scene information of one of the multiple XR scenes, and the second data may correspond to a preference of the user for the one of the XR scenes, and/or an avatar of the user that is used within the XR scene.

For example, the electronic device may include a health application that provides XR experiences for user workouts. The XR experiences may include various virtual environments (e.g., three-dimensional virtual environments) in which workouts can be performed. The XR experiences provided by the server can include a large number of environments to choose from, each having associated three-dimensional video, three-dimensional audio, images, textures, and the like that form large datasets that are not practical to all be stored locally at the electronic device 102. In one or more implementations, the user may obtain the first data by downloading a particular one of the virtual environments, and may perform a workout in the downloaded virtual environment using the electronic device 102. For example, a user may work out every Wednesday at 6 am in a virtual cliffside environment. The device and/or other components of the edge network may determine that the data for the virtual cliffside environment is not needed at the electronic device 102 until the next Wednesday at 6 am. The device may locally delete the data for the virtual environment after the workout is done. The device may cache the cliffside environment (e.g., or another most-used environment) at the user's electronic device 119, and then re-acquire the data for the virtual environment from the electronic device 119 before the next expected or scheduled workout, such as at 5 am on the following Wednesday. The electronic device 119 may store the data for the virtual environment continuously, move the data to another node of the personal edge network, or delete and re-acquire the data from the remote source, in various implementations.

In one or more implementations, the electronic device 119 (for example) may be chosen as the storage node of the personal edge network based on the location of the electronic device 119 and/or the properties of the electronic device 119. For example, the electronic device 119 may be located in the room in which the user does the Wednesday morning workouts, and is thus proximal to the electronic device 102 at the time of the workouts (e.g., and thus available transfer the data back to the electronic device 102 before or during the workout and/or to handle parallel computing tasks with the electronic device 102 for the workout in the virtual environment).

In various implementations, the second data can include a time or a location corresponding to the obtaining of the first data from the first user. In various implementations, the second data may include personally identifiable information for the user. For example, although the virtual environment may be available to many users, the information indicating that the virtual environment is a preferred environment of the user, the time and date of the user's workouts, and/or other information provided to the electronic device 102 by the user and/or learned by the electronic device 102 to predict and/or provide the caching services, is considered user-related data (e.g., the second data of block 704) for which the edge caching is restricted to enrolled nodes within the user's own personal edge network (e.g., the second data cannot be cached to nodes outside of the user's own personal edge network).

In another example, an electronic device may perform visual search operations based on a user's gaze as determined by the electronic device, and obtain publicly available data (e.g., a map of a bus route) based on the user's gaze. For example, the electronic device may use one or more cameras and/or other sensors to “see” a sign for bus routes, and may determine a particular bus route being viewed by the user using gaze tracking operations. The device may fetch a publicly available map of the bus route based on the user's gaze. Thus, although the bus route is publicly available, the user's gaze information and/or interest in and/or use of the bus route is private user-related information for which the edge caching is restricted to enrolled nodes within the user's own personal edge network.

In various implementations, the caching of the data among the user's personal edge network and the remote edge network can be performed to provide efficient availability of data based on device-learned and/or user-provided times, locations, applications, or other signals that can indicate upcoming scheduled (e.g., in a calendar on the user's device(s)) and/or predicted user and/or device activities.

At block 706, the electronic device (e.g., a data manager 202 at the electronic device) may generate a first policy for management of the first data and a second policy for management of the second data. For example, the first policy may indicate that the first data can be stored at remote storage nodes of a remote edge network that is accessible by multiple users. For example, the second policy may indicate that the second data can only be stored at personal storage nodes of a personal edge network of the user of the electronic device 102. The second policy may also indicate required and/or preferred hardware and/or software properties of the nodes of the personal edge network to which the second data can be provided.

At block 708, the electronic device may remove (e.g., delete) the first data and the second data from the electronic device.

At block 710, the first data and the first policy may be provided (e.g., by the electronic device 102) to a remote edge network, the remote edge network including one or more storage nodes that are accessible by multiple devices of multiple users (e.g., storage nodes associated with servers 160 and/or servers 180). In one or more implementations, the first data may be provided without a policy. In one or more implementations, the server may be a third party server of a provider that is different from another server of a manufacturer of the electronic device, and the remote edge network includes the other server of the manufacturer of the electronic device.

At block 712 the second data and the second policy may be provided (e.g., by the electronic device 102) to a personal edge network for a first device, the personal edge network comprising one or more devices associated with the first device and the user of the first device, and previously enrolled as storage nodes of the personal edge network for the first device.

FIG. 8 conceptually illustrates an electronic system 800 with which one or more implementations of the subject technology may be implemented. The electronic system 800 can be, and/or can be a part of, the electronic device 102, the electronic device 110, the electronic device 115, the electronic device 117, the electronic device 119, the servers 120, the servers 160, and/or the servers 180 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the electronic device 102 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

The present disclosure recognizes that the use of personal information data, in the present technology, can be used to the benefit of users. For example, the personal information can be used in secure data caching. Further, other uses for personal information data that benefit the user are also contemplated by the present disclosure. For instance, user-related data, avatar data, and/or health and fitness data may be exchanged and used for secure data caching.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of secure data caching, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

In accordance with one or more aspects of the disclosure, a method is provided that includes predicting an upcoming access of data by a user using a first device, based on prior user activity at the first device; obtaining, responsive to the predicting and prior to the upcoming access, the data from a remote source; storing a first portion of the data that is related to the user on a storage node of a personal edge network for the first device, the personal edge network including one or more devices associated with the first device and the user and previously enrolled as storage nodes of the personal edge network for the first device; and storing a second portion of the data that is unrelated to the user on a storage node of a remote edge network, the remote edge network including one or more storage nodes that are accessible by multiple devices of multiple users.

In accordance with one or more aspects of the disclosure, a method is provided that includes obtaining, with an electronic device, first data from a server; generating, with the electronic device, second data associated a user of the electronic device, wherein the server stores the first data as a subset of third data; generating, with the electronic device a first policy for management of the first data and a second policy for management of the second data; removing the first data and the second data from the electronic device; providing the first data and the first policy to a remote edge network, the remote edge network including one or more storage nodes that are accessible by multiple devices of multiple users; and providing the second data and the second policy to a personal edge network for the electronic device, the personal edge network including one or more devices associated with the electronic device and the user of the electronic device, and previously enrolled as storage nodes of the personal edge network for the electronic device

In accordance with one or more aspects of the disclosure, an edge computing system is provided that includes a personal edge network for a first device, the personal edge network including one or more devices associated with the first device and a user of the first device, and previously enrolled as storage nodes of the personal edge network for the first device; and a remote edge network, the remote edge network including one or more storage nodes that are accessible by multiple devices of multiple users and that are remote from the first device and the one or more devices associated with the first device. The edge computing system is configured to: predict an upcoming access of data by a user using a first device, based on prior user activity at the first device; obtain, responsive to the predicting and prior to the upcoming access, the data from a remote source; store a user-specific portion of the data on a personal storage node of the personal edge network; and store a general portion of the data on a remote storage node of the remote edge network.

In accordance with one or more aspects of the disclosure, a method is provided that includes predicting, by a first device, an upcoming access of data by a user using the first device, based on prior user activity at the first device; instructing, by the first device responsive to the predicting and prior to the upcoming access, a personal storage node of a personal edge network for the first device to obtain and store a first portion of the data from a remote source, where the first portion of the data is related to the user, and the personal edge network includes one or more devices associated with the first device and the user and previously enrolled as personal storage nodes of the personal edge network for the first device; and instructing, by the first device responsive to the predicting and prior to the upcoming access, a remote storage node of a remote edge network to obtain and store a second portion of the data that from the remote source, where the second portion of the data is unrelated to the user, and the remote edge network includes one or more remote storage nodes that are accessible by multiple devices of multiple users and that are remote from the first device and the one or more devices associated with the first device.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory. Further, the computer-readable storage medium can include any non-semiconductor

memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
predicting, by a first device, an upcoming access of data by a user using the first device, based on prior user activity at the first device;
instructing, by the first device responsive to the predicting and prior to the upcoming access, a personal storage node of a personal edge network for the first device to obtain and store a first portion of the data from a remote source, wherein the first portion of the data is related to the user, the personal edge network comprising one or more devices associated with the first device and the user and previously enrolled as personal storage nodes of the personal edge network for the first device; and
instructing, by the first device responsive to the predicting and prior to the upcoming access, a remote storage node of a remote edge network to obtain and store a second portion of the data that from the remote source, wherein the second portion of the data is unrelated to the user, the remote edge network comprising one or more remote storage nodes that are accessible by multiple devices of multiple users and that are remote from the first device and the one or more devices associated with the first device.

2. The method of claim 1, wherein the first portion of the data that is related to the user is related to the prior user activity.

3. The method of claim 2, wherein the personal edge network comprises at least one companion device for the first device, the companion device and the first device both associated with a common user account of the user.

4. The method of claim 3, wherein the remote source comprises a remote server of a third party different from a manufacturer of the first device.

5. The method of claim 4, wherein the remote edge network comprises a plurality of remote servers of the manufacturer of the first device.

6. The method of claim 1, wherein each of the one or more devices associated with the first device forms and off-device personal storage node of the personal edge network for the first device, the off-device personal storage node being separate from the first device.

7. The method of claim 1, wherein each of the one or more devices associated with the first device is enrolled by:
receiving a request for enrollment of a current one of the one or more devices, at a server associated with an account of the first device and the current one of the one or more devices;
verifying, by the server, one or more properties of the current one of the one or more devices; and
providing, to the current one of the one or more devices based on the verifying, a certificate of enrollment as a storage node of the personal edge network.

8. A edge computing system, comprising:
a personal edge network for a first device, the personal edge network comprising one or more devices associated with the first device and a user of the first device, and previously enrolled as storage nodes of the personal edge network for the first device; and
a remote edge network, the remote edge network comprising one or more storage nodes that are accessible by multiple devices of multiple users and that are remote from the first device and the one or more devices associated with the first device;
wherein the edge computing system is configured to:
predict an upcoming access of data by a user using a first device, based on prior user activity at the first device;
obtain, responsive to the predicting and prior to the upcoming access, the data from a remote source;
store a user-specific portion of the data on a personal storage node of the personal edge network; and
store a general portion of the data on a remote storage node of the remote edge network.

9. The system of claim 8, wherein the user-specific portion of the data is related to the prior user activity.

10. The system of claim 9, wherein the personal edge network comprises at least one companion device for the first device, the companion device and the first device both associated with a common user account of the user.

11. The system of claim 10, wherein the remote source comprises a remote server of a third party different from a manufacturer of the first device.

12. The system of claim 11, wherein the remote edge network comprises a plurality of remote servers of the manufacturer of the first device.

13. The system of claim 8, further comprising a server configured to enroll each of the one or more devices associated with the first device as personal storage nodes of the personal edge network for the first device.

14. The system of claim 13, wherein the server is associated with an account of the first device and the one or more devices, and wherein the server is configured to enroll each of the one or more devices associated with the first device by, for each of the one or more devices:
receiving a request for enrollment of a current one of the one or more devices;
verifying, by the server, one or more properties of the current one of the one or more devices; and
providing, to the current one of the one or more devices based on the verifying, a certificate or enrollment as a storage node of the personal edge network.

15. A method, comprising:
obtaining, with an electronic device, first data from a server;
generating, with the electronic device, second data associated a user of the electronic device, wherein the server stores the first data as a subset of third data;
generating, with the electronic device, a first policy for management of the first data and a second policy for management of the second data;
removing the first data and the second data from the electronic device;
providing the first data and the first policy to a remote edge network, the remote edge network comprising one or more storage nodes that are accessible by multiple devices of multiple users; and
providing the second data and the second policy to a personal edge network for the electronic device, the personal edge network comprising one or more devices associated with the electronic device and the user of the electronic device, and previously enrolled as storage nodes of the personal edge network for the electronic device.

16. The method of claim 15, wherein the second data includes a time or a location corresponding to the obtaining of the first data from the user.

17. The method of claim 15, wherein the second data includes personally identifiable information for the user.

18. The method of claim 15, wherein the electronic device is a wearable device.

19. The method of claim 18, wherein the third data comprises scene information for a plurality of scenes, the first data comprises the scene information of one of the plurality of scenes, and the second data corresponds to an avatar of the user.

20. The method of claim 15, wherein the server is a third party server of a provider that is different from a server of a manufacturer of the electronic device, and wherein the remote edge network includes the server of the manufacturer of the electronic device.
